(19) United States
(12) Patent Application Publication
(10) Pub. No.: US 2016/0178828 A1
(43) Pub. Date: Jun. 23, 2016

(54) DISPLAY DEVICE AND IMAGE FORMING APPARATUS

(71) Applicant: CANON KABUSHIKI KAISHA, Tokyo (JP)

(72) Inventor: Jun Nakamura, Tokyo (JP)

(21) Appl. No.: 14/954,342

(22) Filed: Nov. 30, 2015

(30) Foreign Application Priority Data
Dec. 22, 2014 (JP) 2014-258333

(51) Int. Cl. F21V 8/00; H04N 1/00

(52) U.S. Cl. CPC G02B 6/0008; H04N 1/0049; H04N 1/00496; G02B 6/0006

(57) ABSTRACT

A light guide member is included, in which a lamp display portion, a lamp display portion different from the lamp display portion, a light source provided corresponding to the lamp display portion, a light source provided corresponding to the lamp display portion, a first rib that shields light between the light source and the light source, a light guide portion that guides light from the light source to the lamp display portion, and a light guide portion that guides light from the light source to the lamp display portion are configured to be integrally formed.

### BACKGROUND OF THE INVENTION

1. Field of the Invention

The present invention relates to a display device provided in an image forming apparatus, such as a copying machine, a printer, or a facsimile device.

2. Description of the Related Art

An operation portion of an image forming apparatus is provided with a display device that displays a state of the image forming apparatus. When a plurality of light sources is provided in the display device, light leak from an adjacently provided light source is caused and a user may wrongly recognizes the light source. To prevent the light leak from the adjacently provided light source, a projection portion having a light shielding property is provided between the light sources in Japanese Patent Laid-Open No. 2008-242170. Accordingly, the light leak from the adjacently provided light source can be prevented.

When a light emitting diode (LED) is used as the light source as in Japanese Patent Laid-Open No. 2008-242170, light emitted from the LED has a property of expanding at a predetermined irradiation angle. Therefore, typically, a light guide member lies between the LED serving as the light source and an opening display portion, and the light emitted from the LED is concentrated so that brightness is improved.

However, in the technology of Japanese Patent Laid-Open No. 2008-242170, a lens and a light guide portion are provided independently of each other in relation to the LED serving as each light source, and are completely partitioned with a projection portion for light shielding. Therefore, the lens and the light guide portion need to be manufactured as separate components for each light source. Accordingly, the components of the light guide members are necessary by the number of the light sources, and there is a problem that the number of components is increased and assemblability is deteriorated.

The present invention solves the above problem, and it is desirable to provide a display device that can reduce the number of components and can prevent the light leak from the adjacently provided light source.

### SUMMARY OF THE INVENTION

An exemplary configuration of the desirable display device according to the present invention includes: a first opening display portion; a second opening display portion different from the first opening display portion; a first light source provided corresponding to the first opening display portion; a second light source provided corresponding to the second opening display portion; a light shielding portion configured to shield light between the first light source and the second light source; and a light guide member configured to integrally include a first light guide portion that guides light from the first light source to the first opening display portion and a second light guide portion that guides light from the second light source to the second opening display portion.

Further features of the present invention will become apparent from the following description of exemplary embodiments with reference to the attached drawings.

### BRIEF DESCRIPTION OF THE DRAWINGS

FIG. 1 is a perspective explanatory diagram illustrating a configuration of an image forming apparatus including a display device according to the present invention.

FIG. 2 is a sectional explanatory diagram illustrating the configuration of an image forming apparatus including the display device according to the present invention.

FIG. 3 is a perspective view illustrating the configuration of a display device according to the present invention.

FIG. 4 is a plan view illustrating an enlarged portion of FIG. 3.

FIG. 5 is a perspective explanatory diagram illustrating a configuration of a light guide member of the display device according to the present invention.

FIG. 6 is a sectional explanatory diagram for describing a light guide route length of the light guide member.

FIG. 7A is a perspective explanatory diagram illustrating a configuration of the display device according to the present invention.

FIG. 7B is a partially enlarged diagram of FIG. 7A.

### DESCRIPTION OF THE EMBODIMENTS

An embodiment of an image forming apparatus including a display device according to the present invention will be specifically described with reference to the drawings.

### <Image Forming Apparatus>

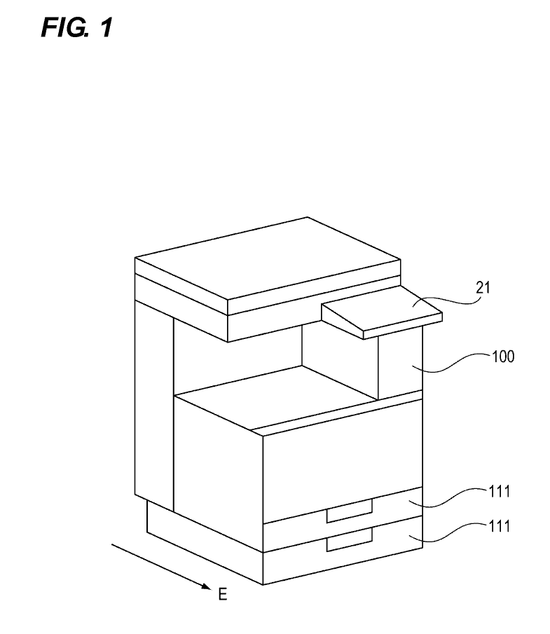

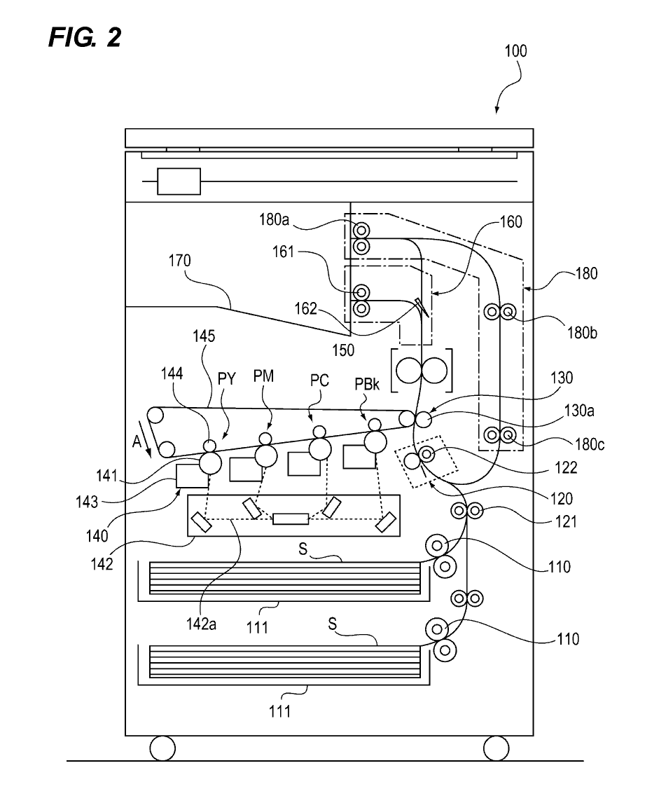

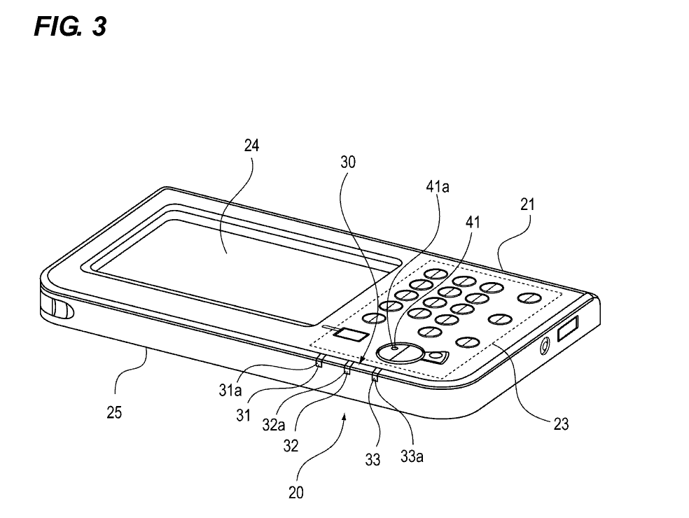

First, a configuration of an image forming apparatus 100 including a display device 20 according to the present invention will be described using FIGS. 1 and 2. As illustrated in FIG. 1, an operation portion 21 that is operated by a user is provided in a front upper portion of the image forming apparatus 100. The display device 20 illustrated in FIG. 3 is provided in the operation portion 21.

As illustrated in FIGS. 1 and 2, a sheet cassette 111 is provided in a lower portion of the image forming apparatus 100. The sheet cassette 111 is drawably provided in the arrow E direction of FIG. 1 (a front direction of FIG. 2).

A sheet S on which a toner image is to be formed by an image forming portion 140 is accommodated in the sheet cassette 111. As the sheet S set in the sheet cassette 111 by the user, a sheet or an overhead transparency (OHT) sheet (a transparent sheet used for an overhead projector (OHP)), or the like is appropriately used.

Four sets of image forming process portions PY, PM, PC, and PBk for yellow Y, magenta M, cyan C, and black Bk colors are provided in the image forming portion 140 illustrated in FIG. 2.

Meanwhile, image information transmitted from an external connection cable (not illustrated) to the image forming apparatus 100 is processed by a controller (not illustrated). Further, laser light 142a is emitted from a laser scanner unit 142, serving as an image exposure portion, according to a signal based on a result of the processing, and an electrostatic latent image is formed on a surface of a photosensitive drum 141 serving as an image carrier uniformly charged by a charging portion (not illustrated).

The electrostatic latent image formed on the surface of the photosensitive drum 141 is supplied a toner from a developing device 143 serving as a developing portion and is developed. Thereby, a toner image is formed on the surface of the photosensitive drum 141.

An intermediate transfer belt 145 is stretched facing the photosensitive drums 141 of the yellow Y, magenta M, cyan C, and black Bk colors. Primary transfer rollers 144 that face the photosensitive drums 141 of the respective colors and serve as a primary transfer portion at an inner peripheral surface side of the intermediate transfer belt 145 are provided.

When predetermined pressure and electrostatic load bias are applied by the primary transfer rollers 144 serving as a primary transfer portion, the toner images formed on the surfaces of the photosensitive drums 141 of the respective colors are primarily transferred onto an outer peripheral surface of the intermediate transfer belt 145.

The intermediate transfer belt 145 is driven and conveyed in the arrow A direction of FIG. 2. Accordingly, parallel processing is performed with the image forming portions PY, PM, PC, and PBk for the yellow Y, magenta M, cyan C, and black Bk colors. An image forming process of the respective colors is performed at timing of overlapping the image with an upstream toner image primarily transferred on the outer peripheral surface of the intermediate transfer belt 145. As a result, a full color toner image is finally formed on the outer peripheral surface of the intermediate transfer belt 145. Then, the toner image is conveyed to a secondary transfer portion 130 that is faced by a secondary transfer roller 130a.

Meanwhile, the sheets S, such as sheets or OHT sheets, stacked and housed in the sheet cassette 111 are separated and fed by a feed portion 110 one by one. The fed sheet S is passed to a second conveying roller 121, and is conveyed toward a sheet skew feeding correction device 120 arranged at a downstream side of a sheet conveying direction (hereinafter, simply referred to as “downstream side”). Skew feeding of the sheet S is corrected by the sheet skew feeding correction device 120. Following that, the sheet S passed to a first conveying roller 122 is further conveyed to the secondary transfer portion 130 by the first conveying roller 122.

The full color toner image formed on the outer peripheral surface of the intermediate transfer belt 145 is secondarily transferred onto the sheet S in the secondary transfer portion 130 in cooperation between the conveying process and the image forming process of the sheet S. Following that, the sheet S is conveyed to a fixing device 150 serving as a fixing portion.

The fixing device 150 adds a predetermined pressure with facing rollers or a belt and a heating effect by a heat source such as a heater to melt and fix the toner on the sheet S. The sheet S on which the toner image is fixed passes through a discharge portion 160, and is discharged onto a discharge tray 170 with a discharge roller 161 in a case of single-side printing.

Meanwhile, in a case of both-side printing of the sheet S, the sheet S is conveyed to an inverting path 180 by switching of a direction of a switch flapper 162. The sheet S is conveyed with inverting rollers 180a to 180c provided in the inverting path 180, and is again conveyed toward the sheet skew feeding correction device 120 in a state where the sheet S is turned over. Accordingly, the image formation is performed on a back surface side of the sheet S, similarly to the single-side printing.

### <Display Device>

Next, a configuration of the display device 20 provided in the operation portion 21 will be described using FIGS. 3 to 6. The operation portion 21 operated by the user is provided in the image forming apparatus 100 illustrated in FIG. 1. As illustrated in FIG. 3, an input portion 23 including numeric keypads used to input various types of information to the image forming apparatus 100 is provided in the operation portion 21. Further, a liquid crystal display portion 24 that visualizes input/output information of the image forming apparatus 100 is provided. Still further, the display device 20 that displays a state of the image forming apparatus 100 is provided.

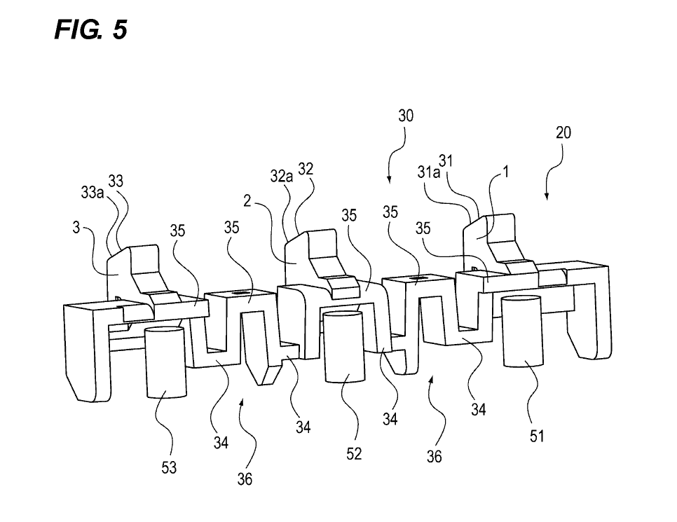

As illustrated in FIG. 3, lamp display portions 31 to 33 serving as a plurality of opening display portions are provided in the display device 20. As illustrated in FIG. 5, a plurality of light sources 51 to 53, which are provided corresponding to the lamp display portions 31 to 33, is provided in vicinity to and immediately below the respective lamp display portions 31 to 33. The light sources 51 to 53 of the present embodiment are configured to include light emitting diodes (LEDs).

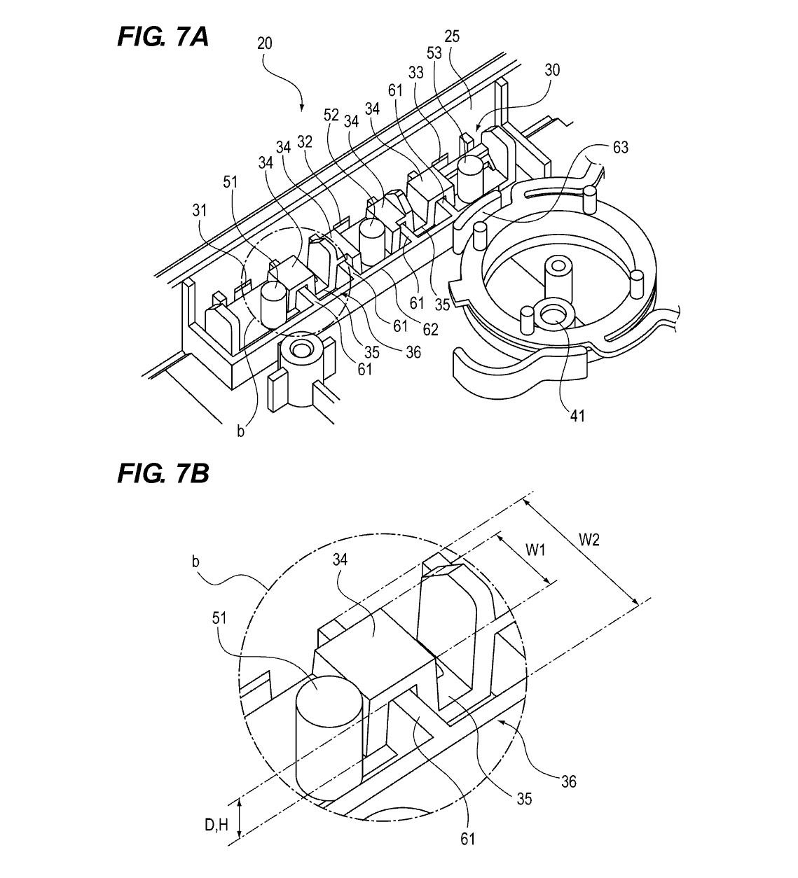

As illustrated in FIG. 7A, a pair of first ribs 61 serving as light shielding portions is arranged between adjacent two of the light sources 51 to 53. The light shielding portion shields light between adjacent two of the light sources 51 to 53.

Light emitting surfaces 31a to 33a made of top faces of the lamp display portions 31 to 33 are configured as light emitting portions provided in the lamp display portions 31 to 33. As illustrated in FIG. 5, a light guide member 30 made of a light guide material is configured to be integrally formed. The light guide member 30 guides light from the plurality of light sources 51 to 53 respectively to the light emitting surfaces 31a to 33a serving as the light emitting portions respectively provided in the plurality of lamp display portions 31 to 33.

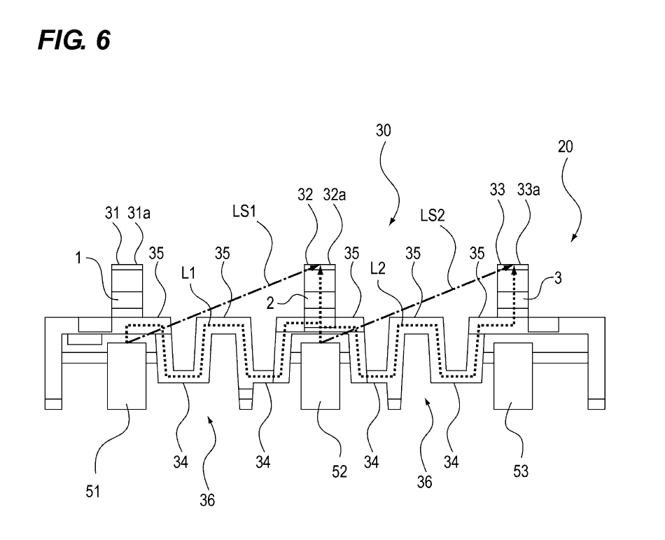

The light guide member 30 of the present embodiment includes light guide portions 1 to 3 that guide the light emitted from the light sources 51 to 53 to the lamp display portions 31 to 33 serving as the opening display portions provided corresponding to the light sources 51 to 53, as illustrated in FIGS. 5 and 6. Further, the light guide member 30 includes a light attenuation portion 36 having a crank shape in cross section, in which recessed portions 34 and protruding portions 35 serving as connection portions that connect the light guide portions 1 to 3 are alternately continued. The light attenuation portion 36 is provided between adjacent two of the light guide portions 1 to 3 illustrated in FIGS. 5 and 6 to go around the first ribs 61 serving as the light shielding portion illustrated in FIG. 7A. In the light guide member 30, the light guide portions 1 to 3 and the light attenuation portions 36 serving as the connection portions are configured to be integrally formed.

In the light guide member 30 illustrated in FIG. 5, the light guide portions 1 to 3 and the light attenuation portions 36 provided between adjacent two of the light guide portions 1 to 3 are configured as a light guide region that guides the light from the light sources 51 to 53 The light attenuation portions 36 have a crank shape in cross section, in which the recessed portions 34 and the protruding portions 35 serving as the connection portion are alternately continued.

As illustrated in FIG. 7A, the first ribs 61 (first and second light shielding portions) serving as the light shielding portions that shield light between adjacent two of the light sources 51 to 53 (first and second light sources) are arranged. The first ribs 61 (the first and second light shielding portions) are respectively inserted into the recessed portions 34 (first and second recessed portions) of the light attenuation portion 36 of the light guide member 30.

In the present embodiment, the light from the light sources 51 to 53 is prevented from being guided to second opening display portions that are different from first opening display portions respectively corresponding to the light sources 51 to 53. Therefore, as illustrated in FIG. 6, light guide route lengths L1 and L2 of the light guide member 30 from the respective light sources 51 to 53 to the respective light emitting surfaces 31a to 33a, serving as the light emitting portions provided in the second opening display portions, are as follows. The light guide route lengths L1 and L2 are set to become longer than shortest distances Ls1 and Ls2, respectively. The shortest distances Ls1 and Ls2 are illustrated by the straight lines of FIG. 6 from the respective light sources 51 to 53 to the respective light emitting surfaces 31a to 33a serving as the light emitting portions provided in the second opening display portions.

The light guide route lengths L1 and L2 of the light guide member 30 illustrated in FIG. 6 are larger than the shortest distances Ls1 and Ls2 illustrated by the straight lines of FIG. 6, in which the light emitted from the respective light sources 51 to 53 directly reach the respective light emitting surfaces 31a to 33a. In this case, the light is attenuated in the light attenuation portion 36 having a crank shape in cross section, in which the recessed portions 34 and the protruding portions 35 are alternately continued.

For example, the second opening display portions different from the lamp display portion 31 serving as the first opening display portion corresponding to the light source 51 illustrated in FIG. 6 are the lamp display portions 32 and 33. Of the lamp display portions 32 and 33, the lamp display portion 32 provided closest to the light source 51 will be considered. The light guide route length L1 of the light guide member 30 from the light source 51 to the light emitting surface 32a serving as the light emitting portion provided in the lamp display portion 32 serving as the second opening display portion is as follows. The light guide route length L1 is set to become longer than the shortest distance Ls1 illustrated by the straight line of FIG. 6 from the light source 51 to the light emitting surface 32a serving as the light emitting portion provided in the lamp display portion 32 serving as the second opening display portion.

Similarly, the second opening display portions different from the lamp display portion 32 serving as the first opening display portion corresponding to the light source 52 illustrated in FIG. 6 are the lamp display portions 31 and 33. Between the lamp display portions 31 and 33, the lamp display portion 33 provided closest to the light source 52 will be considered. The light guide route length L2 of the light guide member 30 from the light source 52 to the light emitting surface 33a serving as the light emitting portion provided in the lamp display portion 33 serving as the second opening display portion is as follows. The light guide route length L2 is set to become longer than the shortest distance Ls2 illustrated by the straight line of FIG. 6 from the light source 52 to the light emitting surface 33a serving as the light emitting portion provided in the lamp display portion 33 serving as the second opening display portion.

Although not illustrated, the magnitude relationship between the light guide route length L from the light source 51 illustrated in FIG. 6 to the light emitting surface 33a of the lamp display portion 33 serving as the second opening display portion, and the shortest distance Ls is also similar. The magnitude relationship between the light guide route length L from the light source 52 to the light emitting surface 31a of the lamp display portion 31 serving as the second opening display portion, and the shortest distance Ls is also similar. Further, the magnitude relationship between the light guide route lengths L from the light source 53 to the light emitting surfaces 31a and 32a of the lamp display portions 31 and 32 serving as the second opening display portions, and the shortest distances Ls is also similarly set.

The light guide member 30 from the light sources 51 to 53 to the light emitting surfaces 31a to 33a, serving as the light emitting portions provided in the second opening display portions, includes the light attenuation portions 36 having a crank shape in cross section, in which the recessed portions 34 and the protruding portions 35 are alternately continued, as illustrated in FIGS. 5 and 6.

Note that the light attenuation portion 36 of the present embodiment is an example of configuration having a crank shape in cross section. As another example, the light guide route length L from the light source illustrated in FIG. 6 to the light emitting surface serving as the light emitting portion of the second opening display portion may be configured to become longer than the shortest distance Ls, using a light attenuation portion 36 having various types of shape such as a waveform shape in cross section.

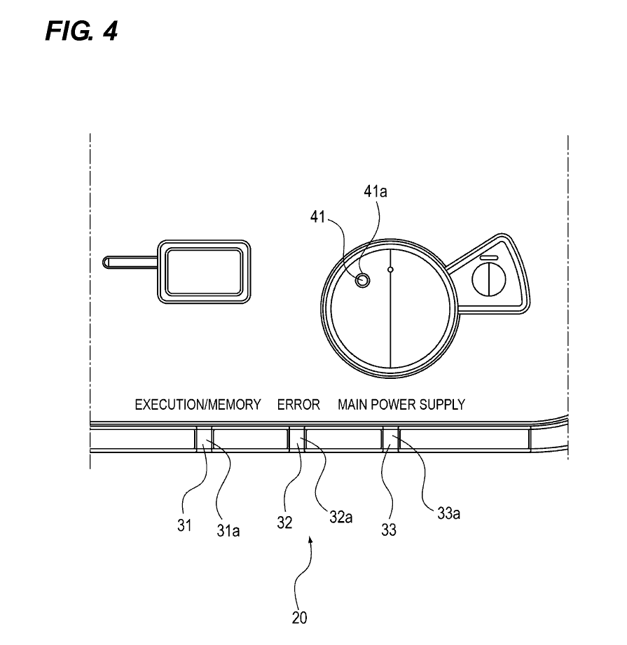

Further, as illustrated in FIGS. 3 and 4, another light guide member 41 made of a light guide material is provided in the various keys provided in the input portion 23. The input portion 23, the liquid crystal display portion 24, and the light guide members 30 and 41 are fixed to a cover 25. In the present embodiment, the lamp display portion 31 illustrated in FIGS. 3 and 4 displays an execution state of the image forming apparatus 100. The lamp display portion 32 displays an abnormal state of the image forming apparatus 100. The lamp display portion 33 displays whether the image forming apparatus 100 is activated.

A lamp display portion 41a of the light guide member 41 illustrated in FIGS. 3 and 4 displays whether the image forming apparatus 100 can perform image formation. As illustrated in FIG. 5, the light guide member 30 is configured to be integrally formed such that the lamp display portions 31 to 33 are linearly arrayed. By providing the light guide member 30 in which the lamp display portions 31 to 33 are integrated, to the plurality of lamp display portion 31 to 33, the number of components can be decreased and the assemblability can be improved.

### COMPARATIVE EXAMPLE

Here, a comparative example will be considered, in which the lamp display portions 31 to 33 are connected with approximately linear light guide members, instead of the light attenuation portions 36 having a crank shape in cross section, in which the recessed portions 34 and the protruding portions 35 illustrated in FIG. 5 are alternately continued. During an operation of the image forming apparatus 100, the lamp display portion 31 illustrated in FIGS. 3 and 4 blinks. The light guide member 30 of the present embodiment illustrated in FIG. 5 is configured to integrally include the lamp display portions 31 to 33.

The comparative example has the configuration in which the lamp display portions 31 to 33 are connected with approximately linear light guide members, instead of the light attenuation portions 36 having a crank shape in cross section, in which the recessed portions 34 and the protruding portions 35 illustrated in FIG. 5 are alternately continued. With such a configuration, the light leak may occur from the lamp display portion 31 to the lamp display portion 32 through the light guide member, for example.

The light leak occurs from the lamp display portion 31 to the lamp display portion 32 illustrated in FIGS. 3 and 4. Then, the user wrongly recognizes that the lamp display portion 32, which displays the abnormal state of the image forming apparatus 100, is blinking as a result of the light leak from the lamp display portion 31 even if the abnormal state is not output from the image forming apparatus 100. Therefore, the user wrongly recognizes that the image forming apparatus 100 indicates the abnormal state even though the image forming apparatus 100 is being normally operated.

### <Prevention of Light Leak>

Next, a principle of prevention of light leak in the display device 20 of the present embodiment will be described using FIGS. 5 to 7. As illustrated in FIG. 5, the light sources 51 to 53 are respectively provided in vicinity to and immediately below the lamp display portions 31 to 33, in the light guide member 30 of the present embodiment. The light sources 51 to 53 independently light up, and output and display the states of the image forming apparatus 100, with the light emission from the light emitting surfaces 31a to 33a serving as the light emitting portions of the lamp display portions 31 to 33 illustrated in FIGS. 3 and 4. The light attenuation portions 36, having a crank shape in cross section in which the recessed portions 34 and the protruding portions 35 are alternately continued, are respectively provided between adjacent two of the lamp display portions 31 to 33, in the light guide member 30, as illustrated in FIG. 5.

As illustrated in FIG. 6, the light guide route length L1 from the light source 51 to the light emitting surface 32a made of a top face of the lamp display portion 32 serving as the second opening display portion adjacently provided to the right side in FIG. 6, in association with the lamp display portion 31 serving as the first opening display portion provided immediately above the light source 51, is as follows. The light guide route length L1 becomes long because it includes the light guide route of the light attenuation portion 36 having a crank shape in cross section, in which the recessed portions 34 and the protruding portions 35 are alternately continued, and being provided between the lamp display portion 31 and the lamp display portion 32 of the light guide member 30.

Therefore, the light guide route length L1 illustrated in FIG. 6 is longer than the shortest distance Ls1 illustrated by the straight line from the light source 51 to the light emitting surface 32a of the lamp display portion 32.

Similarly, the light guide route length L2 from the light source 52 to the light emitting surface 33a made of a top face of the lamp display portion 33 serving as the second opening display portion adjacently provided to the right side in FIG. 6, in association with the lamp display portion 32 serving as the first opening display portion arranged immediately above the light source 52, is as follows. The light guide route length L2 becomes long because it includes the light guide route of the light attenuation portion 36 which has a crank shape in cross section, in which the recessed portions 34 and the protruding portions 35 are alternately continued, and is provided between the lamp display portion 32 and the lamp display portion 33 of the light guide member 30.

Therefore, the light guide route length L2 illustrated in FIG. 6 is longer than the shortest distance Ls2 illustrated by the straight line from the light source 52 to the light emitting surface 33a of the lamp display portion 33. Note that, in the present embodiment, the light guide route length L1 and the light guide route length L2 illustrated in FIG. 6 are set to be equal, and the shortest distance Ls1 and the shortest distance Ls2 are set to be equal.

As illustrated in FIG. 6, the lamp display portion 31 serving as the first opening display portion is arranged immediately above the light source 51. The light guide route length L1 from the light source 51 to the light emitting surface 32a of the lamp display portion 32 serving as the second opening display portion adjacently provided to the right side in FIG. 6, in association with the lamp display portion 31, is as follows. The light guide route length L1 becomes long because it includes the light guide route of the light attenuation portion 36 having a crank shape in cross section, in which the recessed portions 34 and the protruding portions 35 are alternately continued, and being provided between the lamp display portion 31 and the lamp display portion 32 of the light guide member 30.

Therefore, the light guide route length L1 illustrated in FIG. 6 is set longer than the shortest distance Ls1 illustrated by the straight line, assuming the case like the above-described comparative example in which no light attenuation portion 36 is included, and the lamp display portions are connected with the approximately linear light guide members, instead of the light attenuation portions 36.

Similarly, the lamp display portion 32 serving as the first opening display portion is arranged immediately above the light source 52, as illustrated in FIG. 6. The light guide route length L2 from the light source 52 to the light emitting surface 33a of the lamp display portion 33 serving as the second opening display portion adjacently provided to the right side in FIG. 6, with respect to the lamp display portion 32, is as follows. The light guide route length L2 becomes long because it includes the light guide route of the light attenuation portion 36 having a crank shape in cross section, in which the recessed portions 34 and the protruding portions 35 are alternately continued, and being provided between the lamp display portion 32 and the lamp display portion 33 of the light guide member 30.

Therefore, the light guide route length L2 illustrated in FIG. 6 is set longer than the shortest distance Ls2 illustrated by the straight line, assuming the case like the above-described comparative example, in which no light attenuation portion 36 is included and the lamp display portions are connected with the approximately linear light guide members, instead of the light attenuation portions 36.

Accordingly, the light emitted from the light source 51 to 53 is transmitted to the light guide member 30 that includes the light guide routes of the light attenuation portions 36. Therefore, the light is transmitted to the lamp display portions 32 and 33 serving as the second opening display portions adjacently provided, respectively, to the lamp display portion 31 serving as the first opening display portion arranged immediately above the light source 51. Further, the light is transmitted to the lamp display portions 31 and 33 serving as the second opening display portions adjacently provided to the lamp display portion 32, respectively, serving as the first opening display portion arranged immediately above the light source 52. Further, the light is transmitted to the lamp display portions 31 and 32 serving as the second opening display portions adjacently provided to the lamp display portion 33 serving as the first opening display portion arranged immediately above the light source 53.

During the transmission, the light passing through the light attenuation portions 36 is attenuated, and the light emitted from the light sources 51 to 53 can be prevented from being guided to the lamp display portions 31 to 33 adjacently provided, respectively, to the lamp display portions 31 and 33 arranged immediately above the light sources 51 to 53.

In the present embodiment, the light guide member 30 of the lamp display portions 31 to 33 is configured to be integrally formed without being divided. Accordingly, the number of components of the display device 20 is small, and the assemblability is improved. Further, the light attenuation portions 36 having the long light guide route lengths L1 and L2 are provided between adjacent two of the lamp display portions 31 to 33 of the light guide member 30. Accordingly, the light leak from the plurality of light sources 51 to 53 and the respective lamp display portions 31 to 33 can be prevented.

Accordingly, the assemblability of the display device 20 is not impaired. Further, light sources 52 and 53 of the lamp display portions 32 and 33, which are serving as the second opening display portions adjacently provided, respectively, to the lamp display portion 31 serving as the first opening display portion corresponding to the light source 51, light up. Further, the light sources 51 and 53 of the lamp display portions 31 and 33, which are serving as the second opening display portions adjacently provided, respectively, to the lamp display portion 32 serving as the first opening display portion corresponding to the light source 52, light up. Further, the light sources 51 and 52 of the lamp display portions 31 and 32, which are serving as the second opening display portions adjacently provided, respectively to the lamp display portion 33 serving as the first opening display portion corresponding to the light source 53, light up. In such cases, mixture of color can be prevented.

Further, when the light source 51 does not light up but the light sources 52 and 53 adjacently provided to the light source 51 light up, the light leak from the adjacently provided light sources 52 and 53 can be prevented. Still further, when the light source 52 does not light up but the light sources 51 and 53 adjacently provided to the light source 52 light up, the light leak from the adjacently provided light sources 51 and 53 can be prevented. Still further, when the light source 53 does not light up but the light sources 51 and 52 adjacently provided to the light source 53 light up, the light leak from the adjacently provided light sources 51 and 52 can be prevented.

According to the present embodiment, the plurality of light guide members that respectively guide the light from the plurality of light sources 51 to 53 to the light emitting surfaces 31a to 33a of the lamp display portions 31 to 33 serving as the plurality of opening display portions is configured to be integrally formed as the light guide member 30. Accordingly, the number of components of the light guide member can be decreased, and the assemblability can be improved.

Meanwhile, a case where the light from the light source reaches the second opening display portion, which is different from the first opening display portion corresponding to the light source through the integrally formed light guide member 30, can be expected. However, the light guide route length of the light guide member 30 to the second opening display portion different from the first opening display portion corresponding to the light source is longer than the shortest distance from the light source to the second opening display portion. The light is attenuated by the longer length of the light guide route length. Accordingly, the light leak from the adjacently provided light source can be prevented.

That is, the light leak from the light sources 52 and 53 adjacently provided to the light source 51 to the lamp display portion 31 can be prevented. Further, the light leak from the light sources 51 and 53 adjacently provided to the light source 52 to the lamp display portion 32 can be prevented. Further, the light leak from the light sources 51 and 52 adjacently provided to the light source 53 to the lamp display portion 33 can be prevented.

In the light guide member 30 illustrated in FIG. 6, the light attenuation portions 36 having a crank shape in cross section, in which the recessed portions 34 and the protruding portions 35 are alternately continued, and having the long light guide route lengths L1 and L2 are provided between adjacent two of the lamp display portions 31 to 33. Even with such a configuration, when a separate distance between the adjacently provided light sources 51 to 53 is short, or when the light quantity of the light sources 51 to 53 is large, the light emitted from the light sources 51 to 53 may be transmitted from a portion other than the light guide routes made of the light attenuation portions 36 illustrated in FIG. 6.

There is a case in which the light emitted from the light source 51 is guided to the lamp display portions 32 and 33 serving as the second opening display portions adjacently provided, respectively, to the lamp display portion 31 serving as the first opening display portion arranged immediately above the light source 51. There is a case in which the light emitted from the light source 52 is guided to the lamp display portions 31 and 33 serving as the second opening display portions adjacently provided, respectively, to the lamp display portion 32 serving as the first opening display portion arranged immediately above the light source 52. There is a case in which the light emitted from the light source 53 is guided to the lamp display portions 31 and 32 serving as the second opening display portions adjacently provide, respectively, to the lamp display portion 33 serving as the first opening display portion arranged immediately above the light source 53. Therefore, mixture of color or transfer of color may be caused in the lamp display portions 31 to 33.

Therefore, in the present embodiment, as illustrated in FIG. 7A, the light emitted from the light sources 51 to 53 is prevented from being guided to the second opening display portions different from the first opening display portions corresponding to the light sources 51 to 53. Therefore, the pair of first ribs 61 serving as the light shielding portion is provided between the adjacently provided light sources 51 to 53. The first ribs 61, serving as the light shielding portions of the present embodiment, are inserted into the recessed portions 34 that is included in the light attenuation portion 36 of the light guide member 30.

As illustrated in FIG. 7A, one end portion of the first rib 61 is connected to a side wall surface of the cover 25 serving as the light shielding portion, and the other end portion of the first rib 61 is connected to a second rib 62 serving as the light shielding portion. Accordingly, the cover 25, the first ribs 61, and the second rib 62, which serve as the light shielding portion, are provided throughout the whole periphery of the light sources 51 and 52.

As illustrated in FIG. 7A, the first ribs 61 and the second rib 62 having a light shielding property are integrally formed in the cover 25 to which the light guide member 30 is fixed. The first ribs 61 and the second rib 62 are integrally formed to the cover 25 so as to correspond to the uneven shape of the light attenuation portions 36 having a crank shape in cross section, in which the recessed portions 34 and the protruding portions 35 are alternately continued and are provided between adjacent two of the lamp display portions 31 to 33 of the light guide member 30.

FIG. 7B is an enlarged diagram of the b portion illustrated in FIG. 7A. As illustrated in FIG. 7B, the first rib 61, which is configured to have a height H corresponding to a depth D of the recessed portion 34 of the light attenuation portion 36 and a length W2 larger than a width W1 of the recessed portion 34, is inserted into the recessed portion 34. As illustrated in FIG. 7A, two sheets of the first ribs 61 having the light shielding property are arranged between the light source 51 and the light source 52. Further, two sheets of the first ribs 61 having the light shielding property are also arranged between the light source 52 and the light source 53.

Accordingly, the light emitted from the light sources 51 to 53 with the first ribs 61 provided in the cover 25 is as follows. The light can be prevented from being guided to the lamp display portions 32 and 33, which are serving as the second opening display portions adjacently provided, respectively, to the lamp display portion 31 serving as the first opening display portion arranged immediately above (immediately below in FIG. 7A) the light source 51.

Further, the light can be prevented from being guided to the lamp display portions 31 and 33, which are serving as the second opening display portions adjacently provided, respectively, to the lamp display portion 32 serving as the first opening display portion arranged immediately above (immediately below in FIG. 7A) of the light source 52. Still further, the light can be prevented from being guided to the lamp display portions 31 and 32, which are serving as the second opening display portions adjacently provided, respectively, to the lamp display portion 33 serving as the first opening display portion arranged immediately above (immediately below in FIG. 7A) of the light source 53.

Further, in the present embodiment, as illustrated in FIG. 7A, the light emitted from the light sources 51 to 53 can be prevented from being transmitted to the light guide member 41 adjacently provided to the light guide member 30 with the second rib 62 provided in the cover 25 and a third rib 63 serving as the light shielding portion.

The present embodiment has the configuration in which the uneven shape of the light attenuation portions 36 having a crank shape in cross section, in which the recessed portions 34 and the protruding portion 35 are alternately continued, and being provided between adjacent two of the lamp display portions 31 to 33 of the light guide member 30, climbs over the first ribs 61 serving as the light shielding portions. Accordingly, the light guide member 30 of the plurality of light sources 51 to 53 can be configured to be integrally formed, and the number of components of the light guide member of the plurality of light sources 51 to 53 can be reduced.

Similarly, the rib having the light shielding property and serving as the light shielding portion is provided around the adjacently provided various keys provided in the input portion 23 illustrated in FIG. 3. Accordingly, the light leak between the adjacent provided various keys can be prevented.

The light guide member 30 of the present embodiment includes the light guide portions 1 to 3 for guiding the light emitted from the light sources 51 to 53, respectively, to the lamp display portions 31 to 33 (first opening display portions) provided immediately above and corresponding to the light sources 51 to 53 of FIGS. 5 and 6. Further, the light guide member 30 includes the light attenuation portions 36 (connection portions) having a crank shape in cross section and being provided between adjacent two of the light guide portions 1 to 3 to go around the first ribs 61 (light shielding portions) that shield the light between adjacent two of the light sources 51 to 53, wherein the light attenuation portions 36 has the recessed portions 34 and the protruding portions 35 that are alternately continued and connecting the light guide portions 1 to 3.

In the light guide member 30, the light guide portions 1 to 3 and the light attenuation portions 36 (connection portions) are configured to be integrally formed, whereby the number of components can be reduced. Further, the light leak from the adjacently provided light sources 51 to 53 can be prevented with the first ribs 61 (light shielding portions).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-258333, filed Dec. 22, 2014, which is hereby incorporated by reference herein in its entirety.

What is claimed is:

1. A display device comprising:
a first opening display portion;
a second opening display portion different from the first opening display portion;
a first light source provided corresponding to the first opening display portion;
a second light source provided corresponding to the second opening display portion;
a light shielding portion configured to shield light between the first light source and the second light source; and
a light guide member configured to integrally include a first light guide portion that guides light from the first light source to the first opening display portion and a second light guide portion that guides light from the second light source to the second opening display portion.

2. The display device according to claim 1, wherein
the light guide member includes a light attenuation portion having a crank shape in cross section, in which a recessed portion and a protruding portion are alternately continued, and
the light shielding portion is inserted and provided in the recessed portion.

3. The display device according to claim 2, wherein
a first light shielding portion and a second light shielding portion are arranged between the first light source and the second light source, and the recessed portion includes a first recessed portion and a second recessed portion in which the first light shielding portion and the second light shielding portion are respectively inserted.

4. The display device according to claim 1, wherein
the light shielding portion is provided throughout a whole periphery of the first and second light sources.

5. An image forming apparatus including an image forming portion configured to form an image on a sheet, the image forming apparatus comprising:
the display device according to claim 1.
